(19) United States
(12) Patent Application Publication
(10) Pub. No.: US 2012/0086731 A1
(43) Pub. Date: Apr. 12, 2012

(54) BISTABLE ELECTRO-OPTIC DISPLAY AND DRIVING METHOD THEREOF

(75) Inventors: Tzu-Yi Wu, Kaohsiung County (TW); Yao-Te Fang, Hsinchu City (TW)

(73) Assignee: ITE TECH. INC., Hsinchu (TW)

(21) Appl. No.: 13/005,544

(22) Filed: Jan. 13, 2011

(30) Foreign Application Priority Data
Oct. 12, 2010 (TW) 99134796

(51) Int. Cl. G09G 5/10; G09G 5/00

(52) U.S. Cl. 345/690; 345/204

(57) ABSTRACT

A bistable electro-optic display device and a driving method thereof are provided. The display device includes an overlap detection unit and an overlapping image processing unit. The overlap detection unit compares a first display data and a second display data received by a pixel unit. When a first update region corresponding to the first display data overlaps a second update region corresponding to the second display data, the overlap detection unit outputs an overlapping display data, so as to make a display panel display the first update region and the second update region. The overlapping image processing unit combines the first display data and the second display data according to the comparison result and an overlapping display mode to output the overlapping display data to the overlap detection unit, wherein the overlapping display mode indicates the display priority of the first display data and the second display data.

### CROSS-REFERENCE TO RELATED APPLICATION

This application claims the priority benefit of Taiwan application serial no. 99134796, filed on Oct. 12, 2010. The entirety of the above-mentioned patent application is hereby incorporated by reference herein and made a part of this specification.

### BACKGROUND OF THE INVENTION

1. Field of the Invention

The invention generally relates to a driving device and a driving method thereof. More particularly, the invention relates to a driving device and a driving method of a bistable electro-optic display.

2. Description of Related Art

Due to its features of being light-weight and compact, the liquid crystal display (LCD) has gradually become the display medium of the portable terminal systems (e.g., smartphones and notebook computers) in the recent years, as well as an indispensable part of daily items people use. However, due to portable terminal systems having a limited power supply, the power saving aspect of the LCD can still be improved. The bistable electro-optic display technique has one of the best power saving effects among the display technologies. In this technique, the bistable display unit (e.g. pixel) can maintain a bright or a dark state without any voltage application. The technique earns its bistable name because electricity is required only when the display frame is updated. Moreover, display technologies referred to as multi-stable display techniques can maintain the display unit (or pixel) in a plurality of gray level states, not only in the bright or dark state. Moreover, these multi-stable display techniques are a type of bistable display technique. Furthermore, the bistable electro-optic display technique does not utilize a backlight source to conserve electricity. In other words, a user reads on the display using light reflected thereon, and thus the user is not likely to experience eye fatigue.

Currently, a plurality of display techniques can achieve the bistable effect, for instance the electronic ink (E-ink) display technique, the cholesteric liquid crystal display (ChLED) technique, the electro-phoretic display (EPD) technique, the electrowetting display (EWD) technique, or the quick response-liquid powder display (QR-LPD) technique. Ideally, the bistable display technique can save power consumption by up to several hundred times when compared to traditional liquid crystal display techniques.

However, a conventional bistable electro-optic display is incapable of processing two display data at the same time. When the bistable electro-optic display displays a display data, if another display data is inputted simultaneously, the frame displayed by the bistable electro-optic display is out of order and cannot be identified. At this time, the bistable electro-optic display is left with performing image processing again on the two input display data, and to re-display the frame according to the display data after processing. However, this drastically lowers the display efficiency of the bistable electro-optic display.

### SUMMARY OF THE INVENTION

Accordingly, the invention is directed to a bistable electro-optic display and a driving method thereof capable of enhancing a display efficiency of the bistable electro-optic display.

The invention is directed to a bistable electro-optic display including a display panel and a driving device. The display panel has a plurality of pixel units. The driving device is coupled to the display panel, and is adapted for respectively displaying a first update region and a second update region on the display panel according to a first display data and a second display data. The driving device includes an overlap detection unit and an overlapping image processing unit. The overlap detection unit receives the first display data and the second display data, and is adapted for respectively comparing the first display data and the second display data received by each of the pixel units, and detecting whether the first update region overlaps the second update region. When the first update region overlaps the second update region, the overlap detection unit determines whether an overlapping display mode suitable for the first display data and the second display data exists. When the overlapping display mode suitable for the first display data and the second display data exists, an overlapping display data is outputted, so the display panel displays the first update region and the second update region according to the overlapping display data, in which the overlapping display mode indicates a display priority of the first display data and the second display data. The overlapping image processing unit is coupled to the overlap detection unit, and is adapted for combining the first display data and the second display data according to the comparison result of the first display data and the second display data and the overlapping display mode, so as to output the overlapping display data to the overlap detection unit. According to an embodiment of the invention, when the suitable overlapping display mode for the first and second display data does not exist, the overlap detection unit further outputs a re-display signal, and the host controls the overlap detection unit to re-display the first and second update regions according to the re-display signal.

According to an embodiment of the invention, the bistable electro-optic display includes a host coupled to the driving device, adapted for commanding the driving device to re-display the first and second update regions according to the re-display signal.

According to an embodiment of the invention, when the overlap detection unit determines the gray level values of the overlapping regions of the first and second update regions are the same, the overlapping image processing unit directly uses the first display data or the second display data as the display data in the overlapping display data for display of the overlapping regions.

According to an embodiment of the invention, when the overlap detection unit determines the gray level values of the overlapping regions of the first and second update regions are different, the overlapping image processing unit uses the display data corresponding to the update region of a high display priority in accordance with the overlapping display mode as the display data in the overlapping display data for display of the overlapping regions.

The invention is directed to a driving method of a bistable electro-optic display, in which the bistable electro-optic display includes a display panel having a plurality of pixel units. The driving method of the bistable electro-optic display includes receiving a first display data and a second display data, in which the first display data and the second display data are respectively adapted for displaying a first update region and a second update region on the display panel. Moreover, whether the first update region overlaps the second update region is detected. The first display data and the second display data received by each of the pixel units are respectively compared. When overlapping update regions are detected, whether an overlapping display mode suitable for the first display data and the second display data exists is determined, in which the overlapping display mode indicates a display priority of the update regions corresponding to the first display data and the second display data. When the overlapping display mode suitable for the first display data and the second display data is determined, the first display data and the second display data are combined according to the comparison result of the first display data and the second display data and the overlapping display mode, so as to output an overlapping display data so the display panel displays the first update region and the second update region according to the overlapping display data.

According to an embodiment of the invention, when the overlapping display mode suitable for the first display data and the second display data does not exist, the first and second update regions are re-displayed.

According to an embodiment of the invention, when the gray level values of the overlapping regions of the first and second update regions are the same, the first display data or the second display data is directly used as the display data in the overlapping display data for display of the overlapping regions.

According to an embodiment of the invention, when the gray level values of the overlapping regions of the first and second update regions are different, the display data corresponding to the update region of a high display priority is used in accordance with the overlapping display mode as the display data in the overlapping display data for display of the overlapping regions.

According to an embodiment of the invention, each of the afore-described display data includes a coordinate data and a gray level value data.

In summary, an embodiment of the invention employs the overlap detection unit to detect whether the first update region overlaps the second update region. Moreover, when an overlap occurs, the overlapping image processing unit is also employed for combining the corresponding first display data and the second display data to generate an overlapping display data, so as to instantaneously process an updated frame of the overlapping regions of the first and second update regions, and to display a correct image in the overlapping regions and enhance the display efficiency of the bistable electro-optic display.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a bistable electro-optic display according to an embodiment of the invention.

FIG. 2 is a block diagram of a display processing module of a bistable electro-optic display according to an embodiment of the invention.

FIG. 3 is a flowchart of a driving method of a bistable electro-optic display according to an embodiment of the invention.

FIG. 4 is a schematic view of an overlapping display of update regions according to an embodiment of the invention.

FIG. 5 is a schematic view of an overlapping display of update regions according to another embodiment of the invention.

### DESCRIPTION OF EMBODIMENTS

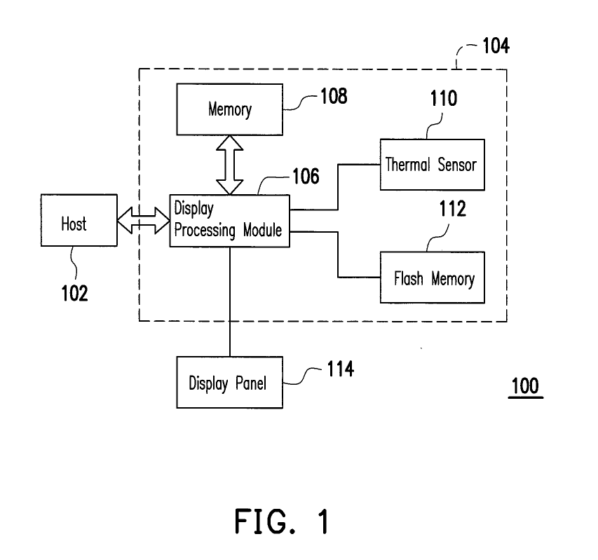

FIG. 1 is a block diagram of a bistable electro-optic display according to an embodiment of the invention. Referring to FIG. 1, a bistable electro-optic display 100 includes a host 102, a driving device 104, and a display panel 114. The driving device 104 is coupled to the host 102 and the display panel 114. The display panel 114 includes a plurality of pixel units (not drawn). In the present embodiment, the host 102 may be a central processing unit (CPU), a digital signal processor (DSP), or other suitable devices which can be connected with the driving device 104. The driving device 104 includes a display processing module 106, a memory 108, a thermal sensor 110, and a flash memory 112.

Moreover, the memory 108 is, for example, a volatile memory that can temporarily store a display data (e.g., in the present embodiment the display data includes a first display data and a second display data) required by the driving device 104 to update the frame of the display panel 114. The display data includes a coordinate data and a gray level value data of the of the pixel unit to be updated. A lookup table may be stored in the flash memory 112, and the thermal sensor 110 is used to measure an environmental temperature. For each of the pixel units, the display processing module 106 may use the gray level values of the original pixel and the pixel to be updated in order to search the lookup table, so as to find a waveform required by the display medium of the driving pixel units. The waveform referred to above represents a curve of an operating voltage and time for a variation of a pixel electrode corresponding to the pixel units, when each of the pixel units is transformed from a specific pixel gray level value to another pixel gray level value.

For example, assume the pixel units in the present embodiment have 16 pixel gray levels, from the pixel gray level value “0” of the dark state to the pixel gray level value of “15” of the bright state. When each of the pixel units in an update region is transformed from the pixel gray level value “0” to another pixel gray level value “5”, the pixel units can use the lookup table to find the corresponding curve of the operating voltage and time for the variation of the pixel electrode. Since the bistable electro-optic display 100 causes variations in the waveform of the driving pixel medium under different environmental temperatures, therefore, the display processing module 106 may adjust the waveform required for gray level value transformation according to the environmental temperature measured by the thermal sensor 110.

The host 102 first transmits a display command to the driving device 104. When the driving device 104 receives the display command from the host 102, the display processing module 106 in the driving device 104 accesses the first display data and the second display data from the memory 108. Moreover, the display processing module 106 displays the corresponding first update region and the second update region according to the first display data and the second display data.

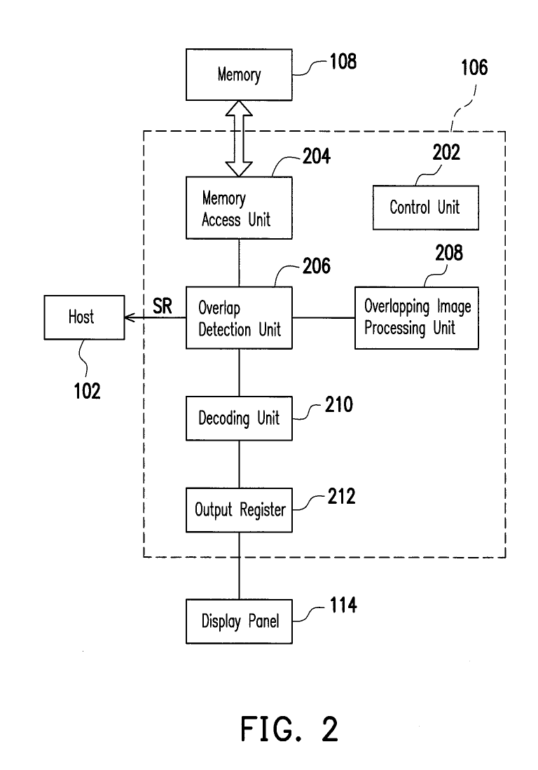

More specifically, the afore-described display processing module 106 may be depicted as in FIG. 2, which is a block diagram of the display processing module 106 according to an embodiment of the invention. Referring to FIG. 2, the display processing module 106 includes a control unit 202, a memory access unit 204, an overlap detection unit 206, an overlapping image processing unit 208, a decoding unit 210 and an output register 212. The control unit 202 is responsible for controlling the overall operation of the display processing module 106, for example to control the memory access unit 204 to access the display data from the memory 108 needed to update the frame of the display panel 114. The overlap detection unit 206 is coupled to the memory access unit 204, the overlapping image processing unit 208, and the decoding unit 210. The output register 212 is coupled to the decoding unit 210.

Moreover, the overlap detection unit 206 is adapted for detecting whether the first update region overlaps the second update region. The overlapping image processing unit 208 is adapted for combining the first display data and the second display data according to an overlapping display mode, so as to generate an overlapping display data which can accurately display the overlapping first and second update regions. Furthermore, the decoding unit 210 decodes the display data as the waveform needed by the pixel units according to the lookup table stored in the flash memory 112. The output register 212 is adapted to temporarily store the waveform data after decoding and to output the waveform data to the display panel 114, so as to display the updated regions on the display panel 114.

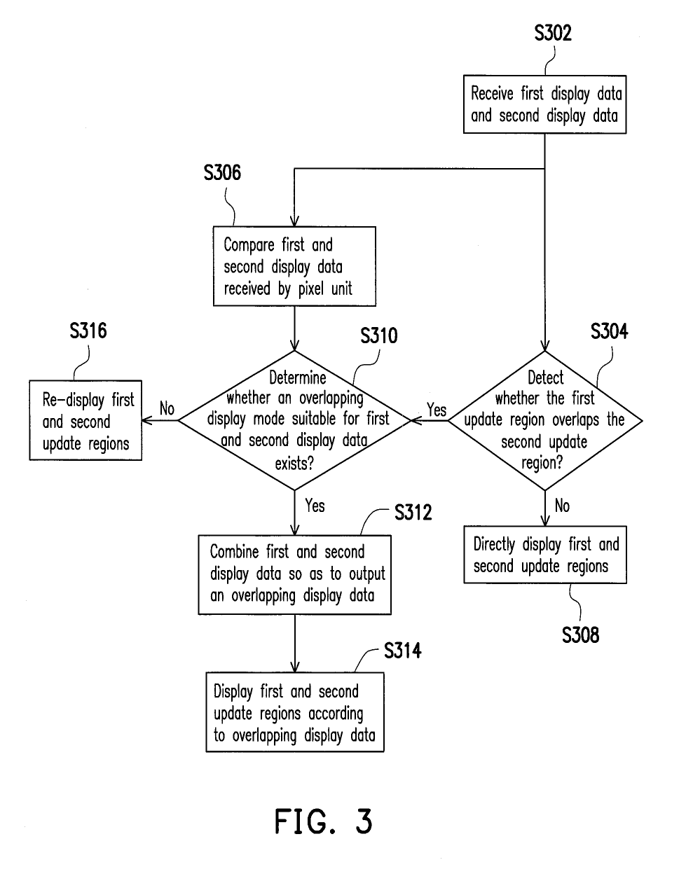

FIG. 3 is a flowchart of a driving method of a bistable electro-optic display according to an embodiment of the invention. A driving method of the bistable electro-optic display 100 is explained in detail below with the accompanying FIGS. 2 and 3. Referring to FIGS. 2 and 3, when the display processing module 106 receives the display command from the host 102, the control unit 202 controls the memory access unit 204 to access the first display data and the second display data temporarily stored in the memory 108, and to transmit the first and second display data to the overlap detection unit 206. After the overlap detection unit 206 receives the first and second display data (Step S302), the overlap detection unit 206 detects whether the first update region overlaps the second update region is detected according to the first and second display data (Step S304). At the same time, the first and second display data received by each of the pixel units in the first update region and the second update region are respectively compared with each other (Step S306). For example, the magnitudes of the gray level values of the first display data and the second display data are compared with each other. When the overlap detection unit 206 detects no overlap between the first update region and the second update region, then the first and second update regions are directly displayed on the display panel 114 according to the first and second display data (Step S308). In other words, the overlap detection unit 206 directly outputs the first and second display data to the decoding unit 210, so as to decode the display data as the waveform data needed for driving the pixel units, and to temporarily store the waveform data in the output register 212 so the waveform data can be outputted to the display panel 114 for display of the updated regions.

When the overlap detection unit 206 detects the first update region overlaps the second update region, then the overlap detection unit 206 further determines whether an overlapping display mode suitable for the first and second display data exists (Step S310). The overlapping display mode may be, for example, a handwriting mode or a watermark mode. When an overlapping display mode suitable for the first and second display data exists, the overlap detection unit 206 transmits the comparison result of the first and second display data from the Step S306 to the overlapping image processing unit 208.

According to the comparison result of the first and second display data and the overlapping display mode, the overlapping image processing unit 208 combines the first and second display data so as to output an overlapping display data (Step S312) to the overlap detection unit 206. Moreover, when the overlapping image processing unit 208 determines the gray level values of the overlapping regions of the first and second update regions are different, the overlapping image processing unit 208 uses the display data corresponding to the update region of a high display priority in accordance with the overlapping display mode as the display data in the overlapping display data for display of the overlapping regions. On the other hand, when the overlapping image processing unit 208 determines the gray level values of the overlapping regions of the first and second update regions are the same, the overlapping image processing unit 208 directly uses the first display data or the second display data as the display data in the overlapping display data for display of the overlapping regions. After the overlap detection unit 206 receives the overlapping display data, the overlap detection unit 206 transmits the overlapping display data to the decoding unit 210, so the display panel 114 displays the first and second update regions in sequence according to the overlapping display data (Step S314).

It should be noted that, the above description used the first and second update regions as an example to illustrate a driving method of the bistable electro-optic display when the update regions overlap each other. However, the afore-described driving method is not limited to the case of two overlapping update regions, since the driving method may also be applied when a plurality of update regions overlap each other.

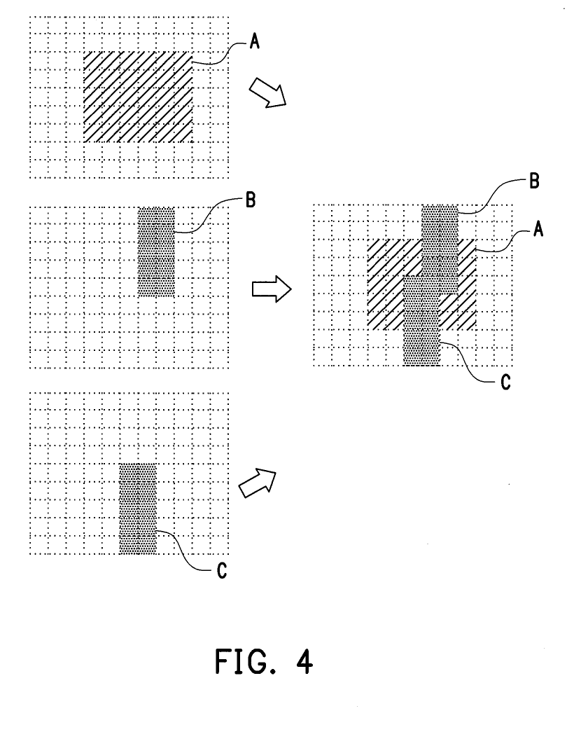

For example, FIG. 4 is a schematic view of an overlapping display of update regions according to an embodiment of the invention. Referring to FIG. 4, assume the overlapping display mode of the present embodiment is a handwriting input mode. As shown in FIG. 4, three update regions A, B, and C are included on the display panel 114, in which an update region A is a background image, and the update regions B and C are line segments produced during a handwritten input. In the handwriting input mode, the display priority of the update region generated by the handwritten input is set higher than the display priority of the update region of the background image. Moreover, the display priority of the update region that is inputted later is higher than the display priority of the update region that is inputted earlier.

As shown in FIG. 4, when the display panel 114 displays the update region A, a user first adds the update regions B and C on the display panel 114 by a handwriting input method. At this time, the overlap detection unit 206 sequentially detects the update region A overlaps the update regions B, and the update region B also overlaps the update region C. Moreover, the overlap detection unit 206 also simultaneously compares the corresponding display data of the update regions A, B, and C. The overlap detection unit 206 determines the display data corresponding to the update regions B and C conforms to the handwriting input mode. Therefore, the overlap detection unit 206 transmits the display data corresponding to the update regions A, B, and C to the overlapping image processing unit 208.

According to the comparison result of the three display data and the overlapping display mode, the overlapping image processing unit 208 combines the three display data so as to output an overlapping display data to the decoding unit 210, so the display panel 114 displays the update regions A, B, and C according to the overlapping display data. For the overlapping regions between the update region A and the update regions B and C, since the update regions B and C have higher display priorities, therefore the overlapping image processing unit 208 uses the display data corresponding to the update regions B and C as the display data in the overlapping display data for the overlapping regions of the update region A and the update regions B and C. For the overlapping region between the update regions B and C, since the update regions B and C have the same gray level values, therefore the overlapping image processing unit 208 uses the display data corresponding to the update region B or the update region C as the display data in the overlapping display data for the overlapping region of the update regions B and C. The display state of the overlapping update regions A, B, and C can be depicted as in FIG. 4, in which the line segments inputted by handwriting (e.g., update regions B and C) cover the background image (e.g. update region A).

Moreover, when the overlap detection unit cannot detect a suitable overlapping display mode for the first and second display data, the overlap detection unit 206 directly outputs the first and second display data to the decoding unit 210, and outputs a re-display signal SR to the host 102. Accordingly, the host 102 is notified that after updating the first and second update regions corresponding to the first and second display data, the overlap detection unit 206 is controlled according to the re-display signal SR to display the first and second update regions again (Step S314).

Accordingly, the overlap detection unit 206 is employed for detecting whether the first update region overlaps the second update region. When an overlap occurs, the overlapping image processing unit 208 is employed for combining the corresponding first display data and the second display data to generate the overlapping display data, so as to instantaneously process an updated frame of the overlapping regions of the first and second update regions, and to display a correct image in the overlapping regions. Therefore, incorrect or blurry images are prevented from being displayed on the overlapping regions of the update regions, and so the host 102 is not required to reissue a command to the driving device 104 to display the first and second update regions on the display panel 114 according to the first and second display data.

According to the afore-described embodiment, when the bistable electro-optic display 100 has a suitable overlapping display mode for the first and second display data, only a time period for the host 102 to transmit two display data (e.g., a transmission time Tt to send each display data) and a time period to display the frame (e.g., a display time Tc) are required to display the overlapping first and second update regions. On the other hand, the conventional method of notifying the host to re-display the first and second update regions require not only the above time periods, but also a calculation period Td for the host to process the overlapping first and second update regions, a time period Tt to transmit the display data after overlap processing, and a time period Tc to re-display the frame. Accordingly, the bistable electro-optic display 100 disclosed by the afore-described embodiment and the driving method thereof can enhance a display efficiency of the bistable electro-optic display 100.

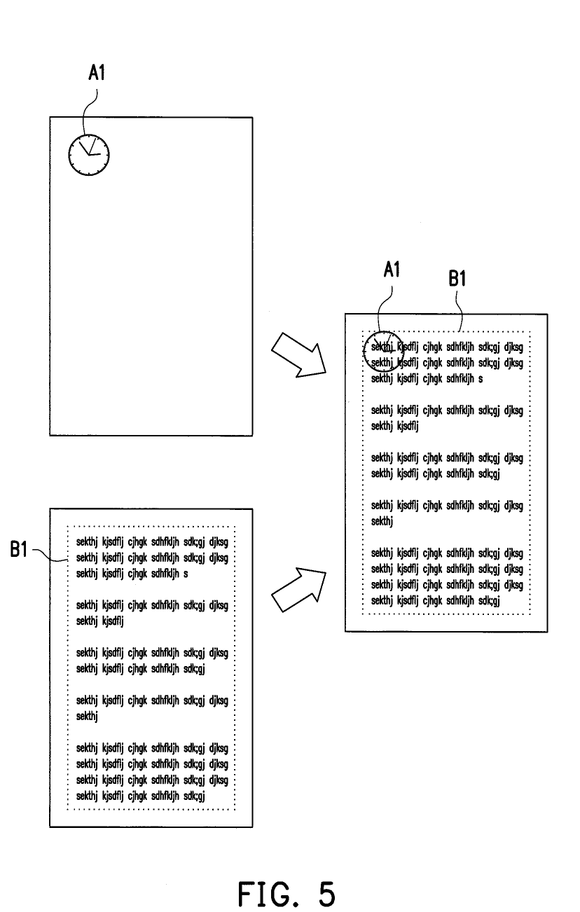

FIG. 5 is a schematic view of an overlapping display of update regions according to another embodiment of the invention. Referring to FIG. 5, assume the overlapping display mode of the present embodiment is a picture-in-picture mode that displays overlapping images corresponding to two display data. As shown in FIG. 5, two update regions A1 and B1 are included on the display panel 114, in which an update region A1 is a clock image, and an update region B1 is a document. In the picture-in-picture mode according to the present embodiment, the display priority of the update region A1 is set higher than the display priority of the update region B1. Moreover, the update regions A1 and B1 may be simultaneously displayed on the display panel 114 by the driving device 104. The display method of the overlapping regions when the update regions A1 and B1 are being displayed is similar to the disclosed method illustrated in FIG. 4, therefore further description thereof is omitted hereafter.

In view of the foregoing, an embodiment of the invention employs the overlap detection unit to detect whether the first update region overlaps the second update region. Moreover, when an overlap occurs, the overlapping image processing unit is also employed for combining the corresponding first display data and the second display data to generate an overlapping display data, so as to instantaneously process an updated frame of the overlapping regions of the first and second update regions, and to display a correct image in the overlapping regions. Therefore, incorrect or blurry images are prevented from being displayed on the overlapping regions of the update regions, and so the host is not required to reissue a command to the driving device to display the first and second update regions on the display panel according to the first and second display data. Thus, not only is power consumption from a power source conserved, the display efficiency of the bistable electro-optic display can be enhanced as well.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A bistable electro-optic display, comprising:
a display panel having a plurality of pixel units; and
a driving device coupled to the display panel, adapted for respectively displaying a first update region and a second update region on the display panel according to a first display data and a second display data, the driving device comprising:
an overlap detection unit receiving the first display data and the second display data, adapted for respectively comparing the first display data and the second display data received by each of the pixel units, and detecting whether the first update region overlaps the second update region, when the first update region overlaps the second update region, the overlap detection unit determines whether an overlapping display mode suitable for the first display data and the second display data exists, when the overlapping display mode suitable for the first display data and the second display data exists, an overlapping display data is outputted, so the display panel displays the first update region and the second update region according to the overlapping display data, wherein the overlapping display mode indicates a display priority of the first display data and the second display data; and
an overlapping image processing unit coupled to the overlap detection unit, adapted for combining the first display data and the second display data according to the comparison result of the first display data and the second display data and the overlapping display mode, so as to output the overlapping display data to the overlap detection unit.

2. The bistable electro-optic display as claimed in claim 1, wherein when the suitable overlapping display mode for the first and second display data does not exist, the overlap detection unit further outputs a re-display signal, and the host controls the overlap detection unit to re-display the first and second update regions according to the re-display signal.

3. The bistable electro-optic display as claimed in claim 2, further comprising:
a host coupled to the driving device, adapted for commanding the driving device to re-display the first and second update regions according to the re-display signal.

4. The bistable electro-optic display as claimed in claim 1, wherein when the overlap detection unit determines the gray level values of the overlapping regions of the first and second update regions are the same, the overlapping image processing unit directly uses the first display data or the second display data as the display data in the overlapping display data for display of the overlapping regions.

5. The driving device of the bistable electro-optic display as claimed in claim 1, wherein when the overlap detection unit determines the gray level values of the overlapping regions of the first and second update regions are different, the overlapping image processing unit uses the display data corresponding to the update region of a high display priority in accordance with the overlapping display mode as the display data in the overlapping display data for display of the overlapping regions.

6. The driving device of the bistable electro-optic display as claimed in claim 1, wherein each of the display data comprises a coordinate data and a gray level value data.

7. A driving method of a bistable electro-optic display, the bistable electro-optic display comprising a display panel having a plurality of pixel units, the driving method comprising:
receiving a first display data and a second display data, wherein the first display data and the second display data are respectively adapted for displaying a first update region and a second update region on the display panel;
detecting whether the first update region overlaps the second update region;
respectively comparing the first display data and the second display data received by each of the pixel units;
when overlapping update regions are detected, determining whether an overlapping display mode suitable for the first display data and the second display data exists, wherein the overlapping display mode indicates a display priority of the update regions corresponding to the first display data and the second display data; and
when the overlapping display mode suitable for the first display data and the second display data exists, combining the first display data and the second display data according to the comparison result of the first display data and the second display data and the overlapping display mode, so as to output an overlapping display data so the display panel displays the first update region and the second update region according to the overlapping display data.

8. The driving method as claimed in claim 7, wherein when the overlapping display mode suitable for the first display data and the second display data does not exist, the first and second update regions are re-displayed.

9. The driving method as claimed in claim 7, wherein when the gray level values of the overlapping regions of the first and second update regions are the same, the first display data or the second display data is directly used as the display data in the overlapping display data for display of the overlapping regions.

10. The driving method as claimed in claim 7, wherein when the gray level values of the overlapping regions of the first and second update regions are different, the display data corresponding to the update region of a high display priority is used in accordance with the overlapping display mode as the display data in the overlapping display data for display of the overlapping regions.

11. The driving method as claimed in claim 7, wherein each of the display data comprises a coordinate data and a gray level value data.
